(19) United States
(12) Patent Application Publication
(10) Pub. No.: US 2009/0257811 A1
(43) Pub. Date: Oct. 15, 2009

(54) Multiple nib writing instrument

(75) Inventor: Bruce Brachman, Springfield, PA (US)

Correspondence Address: AMSTER, ROTHSTEIN & EBENSTEIN LLP, 90 PARK AVENUE, NEW YORK, NY, 10016, US

(73) Assignee: Chance Productions, Inc.

(21) Appl. No.: 12/082,294

(22) Filed: Apr. 10, 2008

(51) Int. Cl. B43K 27/08; B43K 27/04

(52) U.S. Cl. 401/34; 401/35

(57) ABSTRACT

Provided is a writing instrument comprising an elongated barrel. A plurality of marking nibs are disposed at one end of the barrel. An ink-impermeable nib barrier separates each of the nibs. The barrel may be an elongated regular polygon shaped barrel, with each of the nibs being aligned with a corner of the barrel. The nibs may have a curved contour that produces a mark of greater thickness as the writing instrument is angled further away from a perpendicular orientation with a marking surface.

### FIELD OF THE INVENTION

The present invention relates to writing instruments, and more particularly to writing instruments having multiple marking nibs.

### BACKGROUND OF THE INVENTION

Writing instruments having multiple nibs (i.e., writing tips) are known in the art. It also known to deliver different color inks to the nibs to produce marks of different colors on a marking surface.

Conventional multiple nib writing instruments, such as those described in U.S. Pat. No. 4,692,046 (Lan), U.S. Pat. No. 6,155,733 (Holbrook et al.), and U.S. Pat. No. 6,554,517 (Ahmed), can include one or more advanceable and retractable nibs that slide longitudinally to extend beyond a fixed tip of the writing instrument. The nibs are extended individually or in combination to produce marks of different colors.

Other conventional multiple nib writing instruments can include multiple nibs that are fixed in place. For example, some writing instruments, such as those described in U.S. Pat. No. 1,938,835 (Grzyb), U.S. Pat. No. 5,017,034 (Stary et al.), and U.S. Pat. No. 6,953,296 (Vora), include multiple fixed nibs that are spaced apart to define separate marking tips. While other writing instruments, such as those described in U.S. Pat. No. 3,887,287 (Rosh, Jr.), U.S. Pat. No. 7,018,122 (Kwan et al.), U.S. Pat. No. 5,368,405 (Sixiong), U.S. Pat. No. 5,388,924 (Chao), U.S. Pat. No. 6,960,039 (Sieling et al.), and U.S. Pat. No. 7,237,971 (Osborne), include multiple fixed nibs held in close proximity to each other to define a continuous marking tip. The nibs in these conventional fixed multiple nib writing instruments can be used individually to produce a single mark of one color by rotating and angling the writing instrument so that only one of the nibs marks on a marking surface. The nibs can also be used in combination produce multiple marks of different colors that are either spaced apart or continuous, respectively.

However, conventional multiple fixed nib writing instruments have inadequate marking and color selection control, especially for children who may have less dexterity than more accomplished artists. For example, conventional multiple fixed nib writing instruments provide limited control in aligning a nib with a marking surface to produce a mark of a particular color and for controlling the width of the mark.

Accordingly, there is a need for a multiple fixed nib writing instrument with improved marking and color selection control.

### SUMMARY OF THE INVENTION

According to an exemplary embodiment, a writing instrument is provided comprising an elongated regular polygon shaped barrel. A plurality of marking nibs are disposed at one end of the barrel, each of the nibs being aligned with a corner of the barrel. An ink-impermeable nib barrier separates each of the nibs.

According to an exemplary embodiment, a writing instrument is provided comprising an elongated barrel. A plurality of marking nibs are disposed at one end of the barrel. An ink-impermeable nib barrier separates each of the nibs. The nibs have a curved contour that produces a mark of greater thickness as the writing instrument is angled further away from a perpendicular orientation with a marking surface.

These and other features of this invention are described in, or are apparent from, the following detailed description of various exemplary embodiments of this invention.

### BRIEF DESCRIPTION OF THE DRAWINGS

Exemplary embodiments of this invention will be described with reference to the accompanying figures.

FIG. 1 is a perspective view of a writing instrument according to an exemplary embodiment of the present invention.

FIG. 2 is an exploded view of a writing instrument according to an exemplary embodiment of the present invention.

FIG. 3 is a front view of the distal marking end of a writing instrument according to an exemplary embodiment of the present invention.

FIG. 4 is a side view of the distal marking end of a writing instrument according to the present invention.

FIG. 4 illustrates a side view of a writing instrument in a tilted orientation according to an exemplary embodiment of the present invention.

FIG. 5 illustrates a side view of a writing instrument in a vertical orientation according to an exemplary embodiment of the present invention. FIGS. 5A-5B illustrate enlarged views of the distal end of the writing instrument according to exemplary embodiments of the present invention.

FIGS. 6A-6C are a side view, top view, and perspective view, respectively, of a marking nib of the writing instrument according to the present invention.

### DETAILED DESCRIPTION OF THE EXEMPLARY EMBODIMENTS

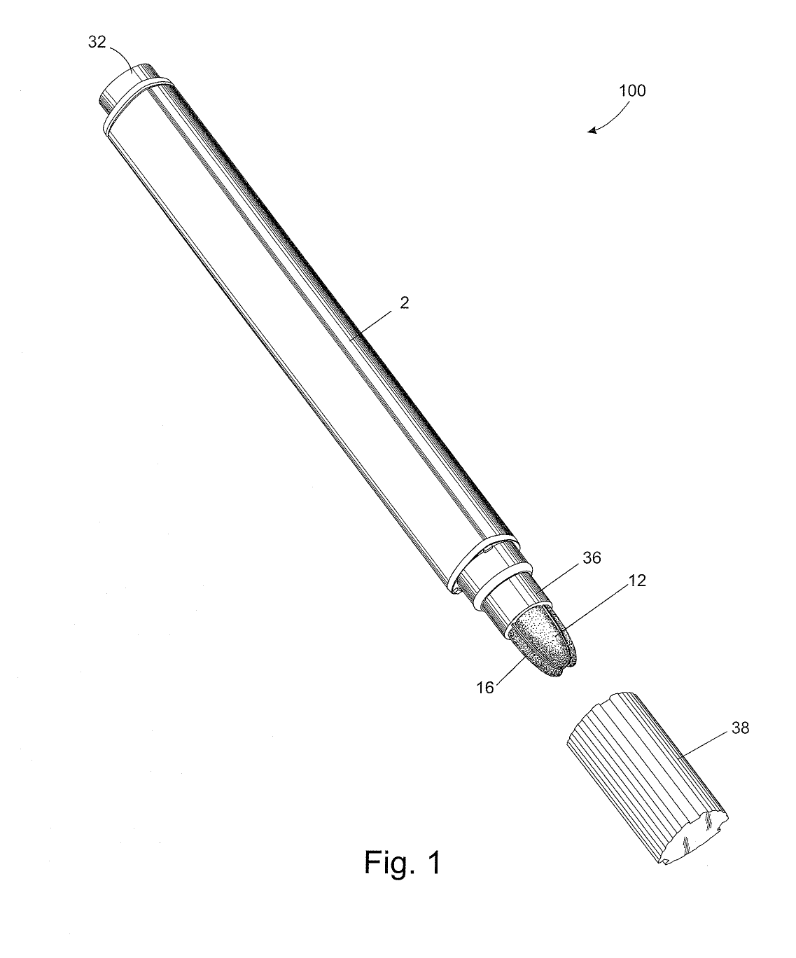

FIGS. 1-6C illustrate a writing instrument 100 according to exemplary embodiments of the present invention. For example, the writing instrument 100 may comprise a marker of various types, such as a highlighter, dry erase marker, permanent marker, acid-free/archival marker, coloring marker, craft marker, or the like.

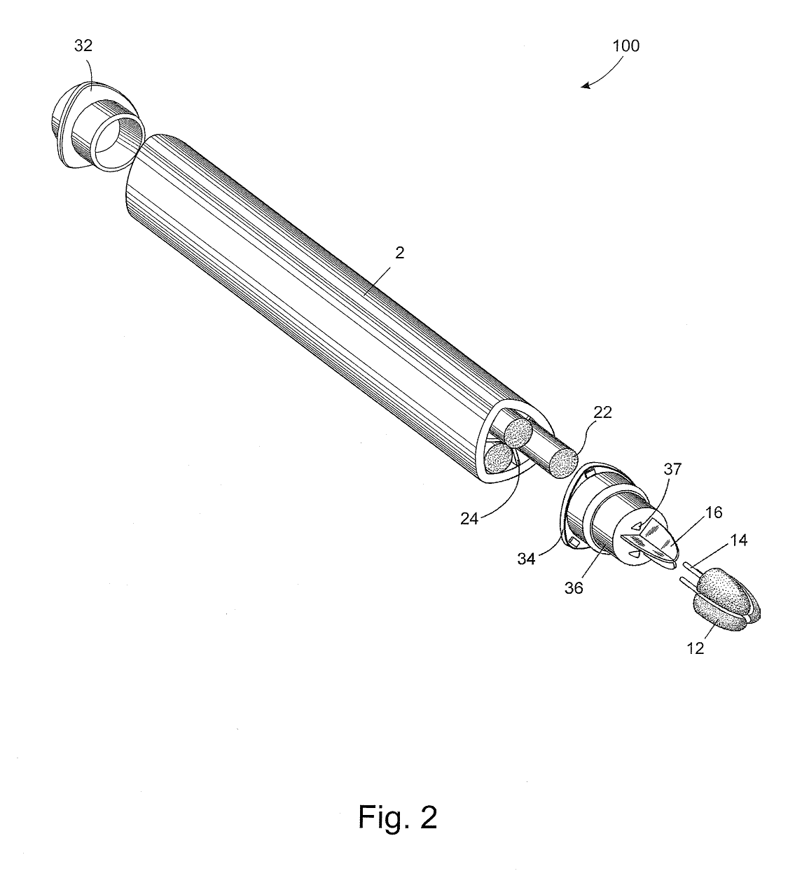

Referring to FIGS. 1-2, the writing instrument 100 includes an elongated hollow barrel 2 and a plurality of marking nibs 12 disposed at the distal end of the barrel 2. While the writing instrument 100 is illustrated as having nibs 12 extending from the distal end of the barrel 2, the writing instrument 100 may also include nibs 12 extending from the proximal end of the barrel 2 to define a double sided writing instrument.

The barrel 2 may have a cross sectional shape of a regular polygon. Preferably, the barrel 2 has a triangular cross sectional shape, however the barrel 2 may have a cross sectional shape of any other regular polygon, such as a square, pentagon, etc.

The barrel 2 internally contains a plurality of ink reservoirs 22. The ink reservoirs 22 may each be provided with a different color or shade of ink. Each ink reservoir 22 provides ink only to a respectively connected nib 12 such that each nib 12 can be used to mark in one particular color or shade of ink.

The ink reservoirs 22 are separated by a reservoir barrier 24. The reservoir barrier 24 forms a series of separate internal chambers, each containing one of the ink reservoirs 22. The reservoir barrier 24 is ink-impermeable and prevents the different inks in the ink reservoirs 22 from mixing together.

For example, in a preferred embodiment, the ink reservoirs 22 are comprised of fibrous porous nib-wicks that contain the different colors or shades of ink. The ink is transferred through each nib-wick to the respective nibs 12 by capillary action.

A nib holder 36 and a seal 34 are provided at the distal end of the barrel 2. The nibs 12 include feed extensions 13 at their proximal ends which are inserted through apertures 37 in the nib holder 36. The feed extensions 14 are used to hold the nibs 12 in fluid connection with the ink reservoirs 22.

The free distal end of the nibs 12 extend outwardly from the nib holder 36 for use for marking. The nibs 12 are separated by a nib barrier 16 extending from the nib holder 36. The nib barrier 16 is ink-impermeable and prevents the different inks in the nibs 12 from mixing together.

An end cap 32 is disposed at the proximal end of the barrel 2. The end cap 32, nib holder 36, and seal 34 provide an otherwise liquid-tight seal for the ink reservoirs 22.

A detachably fitted cap 38 may be provided to enclose the nibs 12 when the writing instrument 100 is not in use.

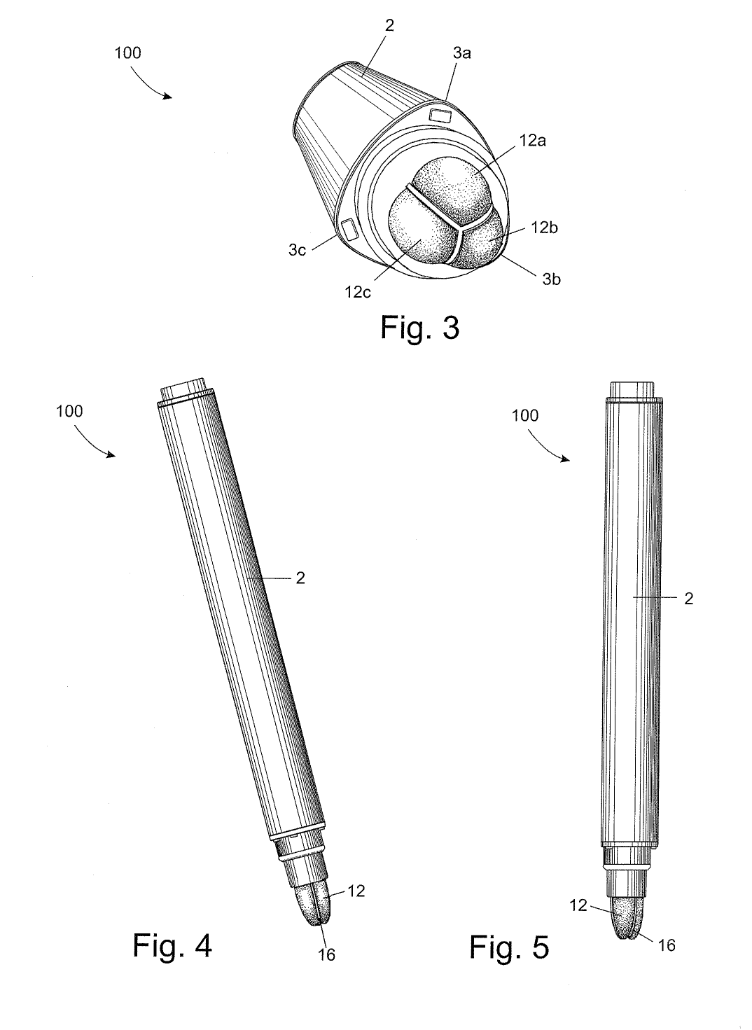

Referring to FIG. 3, each of the nibs 12 may be aligned with one of the corners 3 of the barrel 2. For example, in a preferred embodiment, nibs 12a, 12a, and 12c are aligned with corners 3a, 3b, and 3c respectively. When the writing instrument 100 is held such that one corner 3a of the barrel 2 is pointed toward a marking surface, the corresponding nib 12a is aligned with the marking surface.

A user may prefer to grip the barrel 2 such that rest their forefinger rests on one of the flat sides of the barrel 2. When the barrel 2 is a regular polygon having an odd number of sides (e.g., triangle, pentagon, etc.), the corner 3a opposing the flat side of the barrel 2 is pointed toward with the marking surface, which aligns the corresponding nib 12a with the marking surface. As a result, a user can determine that a nib 12a is aligned with the marking surface by the feel, rather than requiring the user to make a visual inspection or a test of the writing instrument 100 to ensure that the nib 12a is properly aligned.

The nibs 12 may combine together to form a substantially circular marking tip. For example, in a preferred embodiment, each of the three nibs 12a, 12a, 12c form 120° sections that combine to form a circular marking tip. The nib barrier 16 includes integral partition walls defining 120° sections separating each of the nibs 12a, 12a, 12c.

The nibs 12 may be formed so that their distal ends are separated from each other by a distance, thus defining separate marking tips. For example, in a preferred embodiment, the distal ends of each of the three nibs 12a, 12a, 12c form three separate marking tips.

FIG. 4 illustrates the writing instrument 100 in an orientation tilted at angle to a marking surface.

To produce a mark of a single color of ink, the writing instrument 100 is tilted at an angle such that the outer surface of one of the nibs 12 is in contact with the marking surface. When it is desired to change the ink color produced by the writing instrument 100, a user rotates the writing instrument 100 within his/her hand to present the outer surface of a different nib 12 to the marking surface.

It is contemplated that the writing instrument 100 may be rotated such that the outer surfaces of two or more of the nibs 12 concurrently contact the marking surface to produce two or more marks of different colors. However, the nibs 12 and/or nib barrier 16 may be designed to prevent more than one nib from contacting the marking surface.

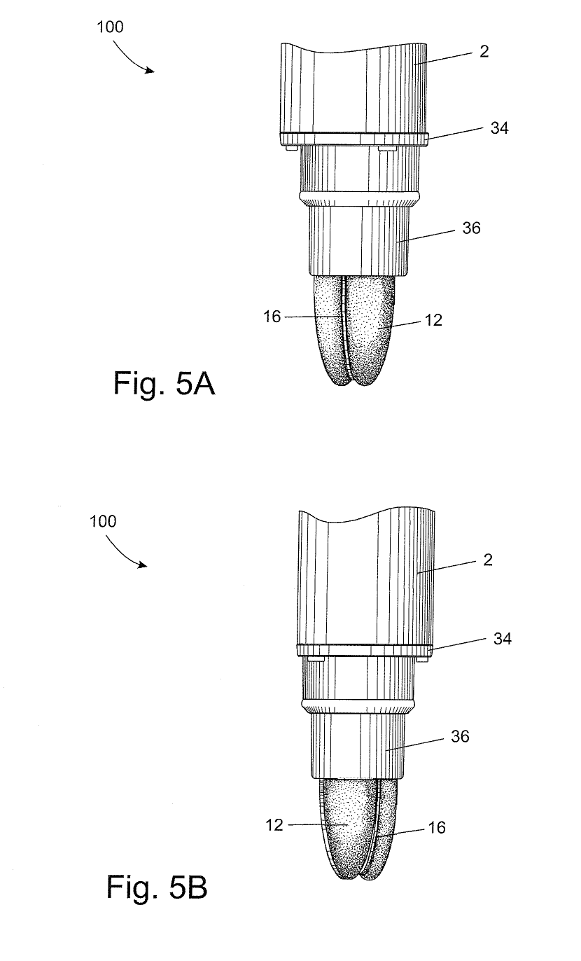

FIG. 5 illustrates the writing instrument 100 aligned vertically in an orientation substantially perpendicular to a marking surface. FIGS. 5A and 5B are enlarged views of the distal end of the writing instrument 100 according to exemplary embodiments.

In an exemplary embodiment shown in FIG. 5A, the distal ends of the nibs 12 may extend beyond the distal end of the nib barrier 14. When the writing instrument 100 is aligned vertically (i.e., substantially perpendicular) with the marking surface, the distal ends of each of the nibs 12 concurrently contact the marking surface. Accordingly, the writing instrument 100 may concurrently produce a plurality of marks of different colors of ink. For example, the writing instrument 100 may produce a plurality of dots (e.g., used in stippling) or a plurality of lines.

In another exemplary embodiment as shown in FIG. 5B, the distal end of the nib barrier 16 may extend beyond the distal end of the nibs 12. When the writing instrument 100 is aligned vertically with the marking surface, the portion of the nib barrier 16 that extends beyond the nibs 12 prevents the distal ends of the nibs 12 from contacting the marking surface. As the writing instrument 100 is tilted away from the vertical orientation (as shown in FIG. 5B), the outer surface of one of the nibs 12 comes in contact with the marking surface allowing the writing instrument 100 to produce a mark.

Accordingly, the extended nib barrier 16 prevents more than one of the nibs 12 from concurrently contacting on a marking surface, and the writing instrument 100 can only produce a single mark of a particular color of ink.

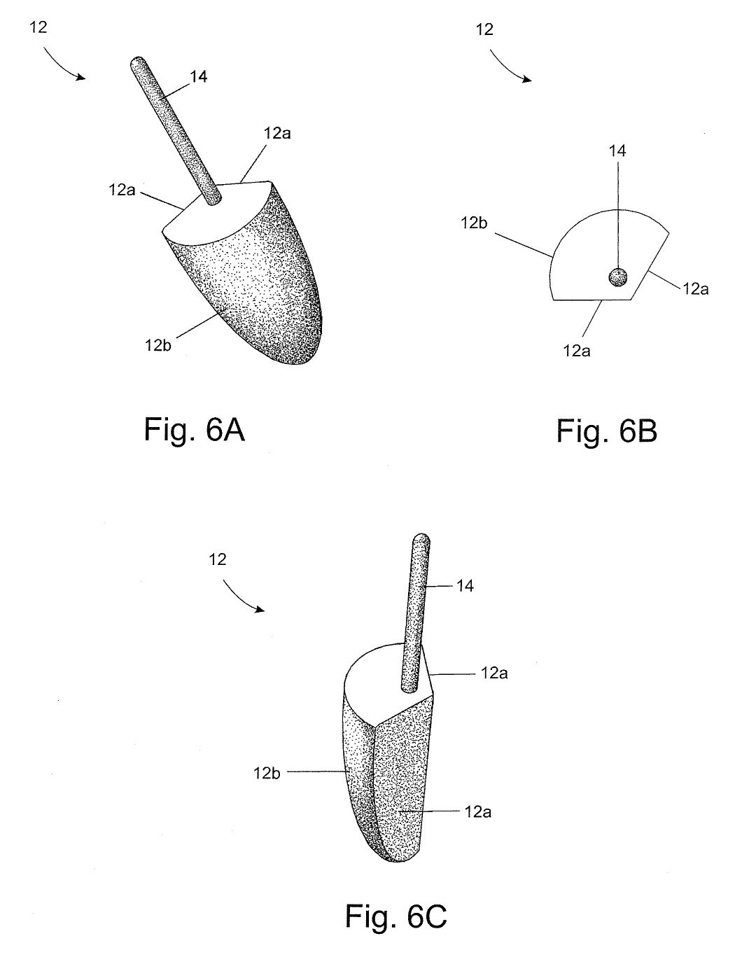

FIGS. 6A-6C illustrate a marking nib 12 of the writing instrument 100. The inner surfaces 12a of the nib 12 are substantially flat planar surfaces that contact the partition walls of the nib barrier 16. The outer surface 12b of the nib 12 is rounded to define a curved contour. The distal end of the nib 12 defines a tip where the inner surfaces 12a and outer surface 12b meet.

The inner surfaces 12a of the nib 12 may curve away from the partition walls of the nib barrier 16 at the distal end of the nib 12. Thus, the distal end of each of the nibs 12 form may form separate marking tips that are spaced apart from each other (see FIG. 3). The space between the distal ends of the nibs 12 enables the tips of the nibs 12 to individually touch the paper, thus allowing thin marks to be produced.

The distal ends of the nibs 12 are defined such that the tips contact the marking surface when the writing instrument 100 is oriented in a vertical orientation (i.e., substantially perpendicular to the marking surface). The outer surface 12b of the nibs 12 are defined such that a minimal portion of the outer surface 12b makes contact with the marking surface when the writing instrument 100 is oriented at a slight angle away from a vertical orientation, and a greater portion of the outer surface 12b makes contact with the marking surface as the writing instrument 100 is tilted further away from a vertical orientation.

As a result, the nib 12 produces a thin mark when the writing instrument 100 is oriented at in a vertical orientation, a relatively thicker mark is produced as the outer surface 12b of the nib 12 begins to contact the marking surface when the writing instrument 100 is tilted slightly away from a vertical orientation, and a gradually thicker mark is produced as the writing instrument 100 is tilted further away from a vertical orientation and more of the outer surface of the nib 12 contacts the marking surface.

Now that exemplary embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A writing instrument comprising:
an elongated regular polygon shaped barrel;
a plurality of marking nibs disposed at one end of said barrel, each of said nibs being aligned with a corner of said barrel; and
an ink-impermeable nib barrier separating each of said nibs.

2. The writing instrument of claim 1, wherein said barrel is an elongated triangle shaped barrel.

3. The writing instrument of claim 1, wherein the distal ends of said nibs extend beyond the distal end of said nib barrier.

4. The writing instrument of claim 3, wherein said distal ends of said nibs extending beyond said distal end of said nib barrier are spaced apart.

5. The writing instrument of claim 1, wherein said nib barrier extends beyond the distal ends of said nibs.

6. The writing instrument of claim 1, wherein said nibs have a curved contour that produces a mark of greater thickness as said writing instrument is angled further away from a perpendicular orientation with a marking surface.

7. The writing instrument of claim 1, further comprising:
a plurality of ink reservoirs extending longitudinally within said barrel, each ink reservoir providing ink to one of said nibs; and
an ink-impermeable reservoir barrier separating each of said ink reservoirs.

8. The writing instrument of claim 1, wherein each of said nibs is provided with a different color ink.

9. A writing instrument comprising:
an elongated barrel;
a plurality of marking nibs disposed at one end of said barrel; and
an ink-impermeable nib barrier separating each of said nibs,
wherein the outer surface of each of said nibs defines a curved contour that produces a mark of greater thickness as said writing instrument is angled further away from a perpendicular orientation with a marking surface.

10. The writing instrument of claim 9, wherein the distal ends of said nibs extend beyond the distal end of said nib barrier.

11. The writing instrument of claim 10, wherein said distal ends of said nibs extending beyond said distal end of said nib barrier are spaced apart.

12. The writing instrument of claim 9, wherein said nib barrier extends beyond the distal ends of said nibs.

13. The writing instrument of claim 9, wherein said barrel is an elongated regular polygon shaped barrel, and wherein each of said nibs are aligned with a corner of said barrel.

14. The writing instrument of claim 13, wherein said barrel is an elongated triangle shaped barrel.

15. The writing instrument of claim 9, further comprising:
a plurality of ink reservoirs extending longitudinally within said barrel, each ink reservoir providing ink to one of said nibs; and
an ink-impermeable reservoir barrier separating each of said ink reservoirs.

16. The writing instrument of claim 9, wherein each of said nibs is provided with a different color ink.
